(19) United States
(12) Patent Application Publication
(10) Pub. No.: US 2007/0034713 A1
(43) Pub. Date: Feb. 15, 2007

(54) Watering nozzle with a rotatable head

(76) Inventors: King-Yuan Wang, Chang-Hua (TW); Shun-Nan Luo, Chang-Hua (TW)

Correspondence Address: KING-YUAN WANG, P.O. BOX 487, CHANG-HUA, 500, TW

(21) Appl. No.: 11/242,186

(22) Filed: Oct. 4, 2005

(30) Foreign Application Priority Data
Jul. 26, 2005 (TW) 094212639

(51) Int. Cl. B05B 3/04

(52) U.S. Cl. 239/263

(57) ABSTRACT

A watering nozzle includes a handle with a trigger to control a valve in an inlet pipe received in the handle. An outlet pipe is connected to the first pipe and an adjusting member has a rear end connected to the outlet pipe. A plurality of first outlets are defined radially in the adjusting member. A rotatable head is threadedly and rotatably connected to the adjusting member and includes a plurality of chambers and each of which has an outward cone-shaped inner periphery, a plurality of tiny holes and elongate holes. The adjusting member is movable linearly when rotating the rotatable head so that water is introduced into one of the chambers via the first outlets so as to generate different watering patterns.

### FIELD OF THE INVENTION

The present invention relates to a watering nozzle which is able to generate different watering patterns by rotating a rotatable head.

### BACKGROUND OF THE INVENTION

A conventional watering nozzle known to applicant is shown in FIG. 10 and generally includes a barrel which is movable along a threaded portion so as to adjust the distance between the patterns of watering. However, it is experienced that after the movable barrel is rotated away from the handle, dust or even pebbles might be stocked on the threaded portion and affects the rotation of the barrel. Another conventional watering nozzle known to the applicant is shown in FIG. 11 and improves the shortcoming of the watering nozzle in FIG. 10. In other words, there will be no exposed threaded portion when rotating the barrel. However, it includes too many parts and a complicated structure. Yet another conventional watering nozzle is disclosed in U.S. Pat. No. 5,333,792 which includes less number of parts.

The present invention intends to provide a watering nozzle which includes a rotatable head and different watering patterns can be generated by rotating the head.

### SUMMARY OF THE INVENTION

The present invention relates to a watering nozzle which includes a handle and an inlet pipe and an outlet pipe which is in communication with the inlet pipe are received in the handle. A valve controlled by a trigger is connected to the inlet pipe. An adjusting member has a rear end connected to the outlet pipe and a front end of the adjusting member is a closed end. A plurality of first outlets are defined radially in the adjusting member and located close to the closed end. A rotatable head has a first chamber, a second chamber and a third chamber defined therein and a periphery of each of the three chambers has an outward cone-shaped inner periphery, a plurality of tiny holes and elongate holes. A board is located in a rear end of the second chamber and a neck extends from the board. A plurality of apertures are defined radially through the neck. A front end of the neck is engaged with the first chamber. The adjusting member is movable linearly when rotating the rotatable head to introduce water to enter into the first chamber, the second chamber or the third chamber via the first outlets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the watering nozzle of the present invention;

FIG. 2 is a cross sectional view of the watering nozzle of the present invention;

FIG. 3 is an end view to show the parallel rails of the outlet pipe are engaged with the grooves of the adjusting member;

FIGS. 4 to 7 show that the adjusting member is moved relative to the rotatable head so that the water goes out from different chambers of the rotatable head;

FIG. 7-1 is an enlarged view to illustrate the position of the adjusting member relative to the rotatable head in FIG. 7;

FIG. 8 shows that the water goes out from the tiny holes of the second chamber;

FIG. 9 shows that the water goes out from the elongate holes of the third chamber;

FIG. 9-1 is an enlarged view to illustrate the position of the adjusting member relative to the rotatable head in FIG. 9;

FIG. 10 shows a conventional watering nozzle;

FIG. 11 shows another conventional watering nozzle; and

FIG. 12 shows the watering nozzle disclosed in U.S. Pat. No. 5,333,972.

### DETAILED DESCRIPTION OF THE PREFERRED EMBODIMENT

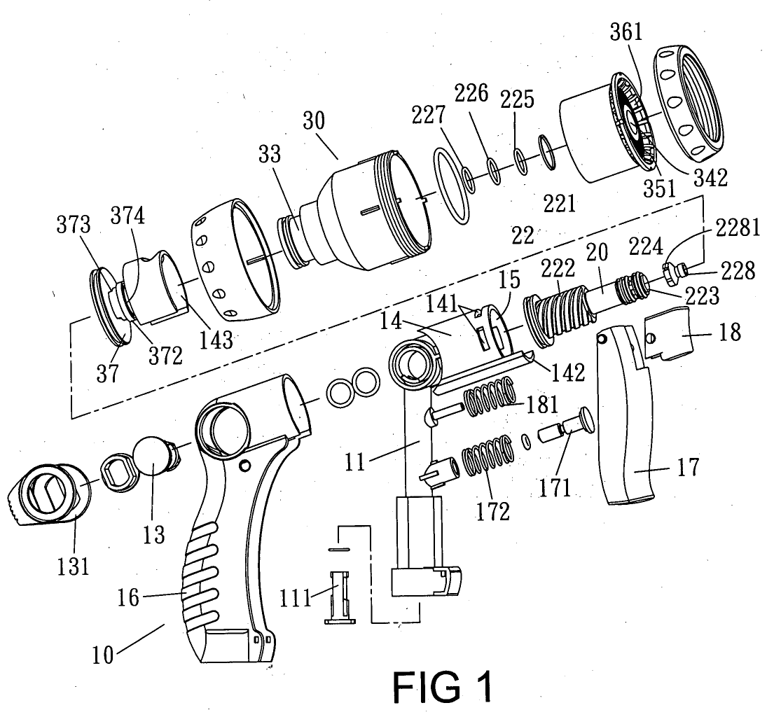

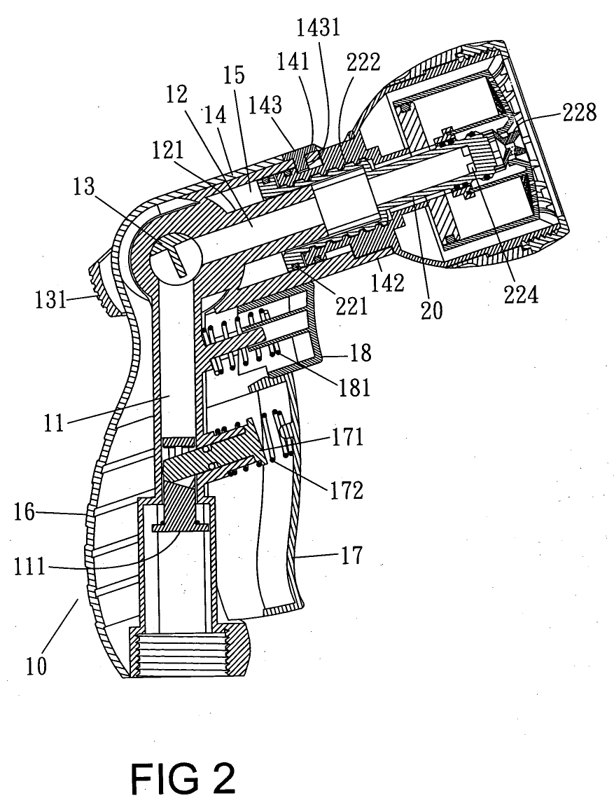

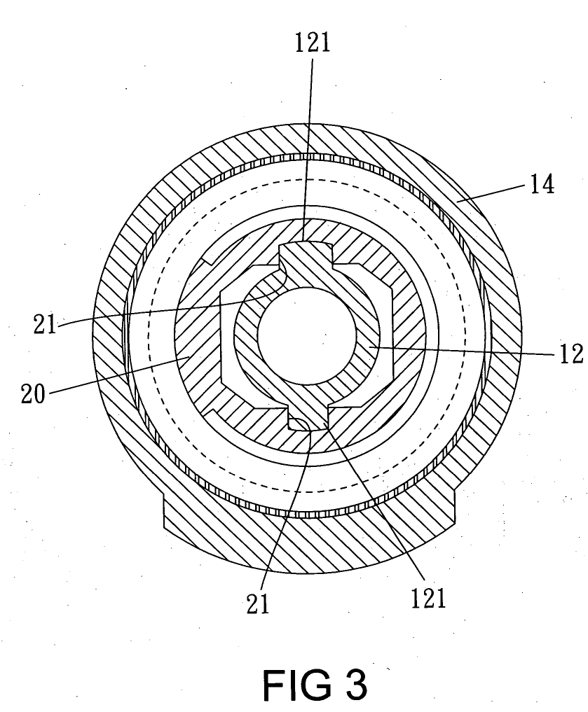

Referring to FIGS. 1 to 3, the watering nozzle 10 of the present invention comprises a handle 16 which has an inlet pipe 11 received therein and a valve 111 is connected to the pipe 11. An outlet pipe 12 is connected to the first pipe 11 and in communication with the inlet pipe 11. The outlet pipe 12 is received in the barrel on connected to a top end of the handle 16. A trigger 17 is pivotably connected to the handle 16 and a push rod 171 cooperated with a spring 172 are connected between the trigger 17 and the pipe 11 so as to keep the trigger 17 at shut-off position. A lock member 18 is pivotably connected to the trigger 18 and cooperated with another spring 181 located between the inlet pipe 11 and the lock member 18 so as to lock the trigger at operation position. A volume control member 13 with a control knob 131 are connected to a rear end of the barrel of the watering nozzle 10.

An adjusting member 20 has a rear end connected to the outlet pipe 12 and a front end of the adjusting member 20 is a closed end 223. A plurality of first outlets 224 are defined radially in the adjusting member and located close to the closed end 223. A first seal 225, a second seal 226, and a third seal 227 are mounted to the adjusting member 20 and the first outlets 224 are located between the first seal 225 and the second seal 226. A nozzle member 228 is connected to the front end of the adjusting member 20 and includes a plurality of orifices 2281 defined radially in a rear end thereof and a passage 2282 is defined longitudinally therein. A front end of the nozzle member 28 includes an outward front end. The rear end of the adjusting member 20 has a flange 22 and a seal 221 is mounted to a periphery of the flange 22, the seal 21 is in contact with an inner periphery of the outer tube 14. An outer tube 14 is connected to the inlet pipe 11 and the outlet pipe 12 is received in the outer tube 14. A space 15 is defined between the outlet pipe 12 and the outer tube 14. The outer tube 14 includes a plurality of snap holes 141 defined therethrough and he a retaining collar 143 is mounted to the outer tube 14. The retaining collar 143 includes a plurality of bosses 1431 extend from an inner periphery thereof so as to be engaged with the snap holes 141. A nozzle member 228 is connected to a front end of the adjusting member 20 and includes a plurality of orifices 2281 defined radially in a rear end thereof and a passage 2282 is defined longitudinally therein, a front end of the nozzle member 28 includes an outward front end.

A rotatable head 30 has a first chamber 34, a second chamber 35 and a third chamber 36 defined therein and a periphery of each of the three chambers having an outward cone-shaped inner periphery 342, a plurality of tiny holes 351 and elongate holes 361. A rear end of the rotatable head 30 and the adjusting member 20 are received in the space 15 defined between the outlet pipe 12 and the outer tube 14. The rear end of the adjusting member 20 includes a threaded outer periphery 222 and the rotatable head 30 has a threaded inner periphery 31 which is connected to the threaded outer periphery 222 of the adjusting member 20. The outlet pipe 12 includes a pair of parallel rails 121 and the rear end of the adjusting member 20 includes grooves 21 with which the rails 121 are slidably engaged. A seal 32 is mounted to a rear end of the rotatable head 30 and in contact with the inner periphery of the outer tube 14. The rotatable head 30 includes an annular recess 33 so that the bosses 1431 of the retaining collar 143 are engaged. An annular mouth 341 extends inward from a front end of the rotatable head 30 and located in the fist chamber 34.

A support extension 142 extends from a lower edge of the outer tube 14 so as to support a neck portion of the rotatable head 30. A board 37 is located in a rear end of the second chamber 35 and a neck 372 extends from the board 37. A plurality of apertures 373 are defined radially through the neck 372 and a front end of the neck 372 is engaged with the first chamber 34. A seal 371 is mounted to the board 37 and in contact with the inner periphery of the second chamber 35. A seal 374 is mounted to the neck 372 so that the an opening of the first chamber can be sealed.

The adjusting member 20 is movable linearly when rotating the rotatable head 30 to introduce water to enter into the first chamber 34, the second chamber 35 or the third chamber 36 via the first outlets 224.

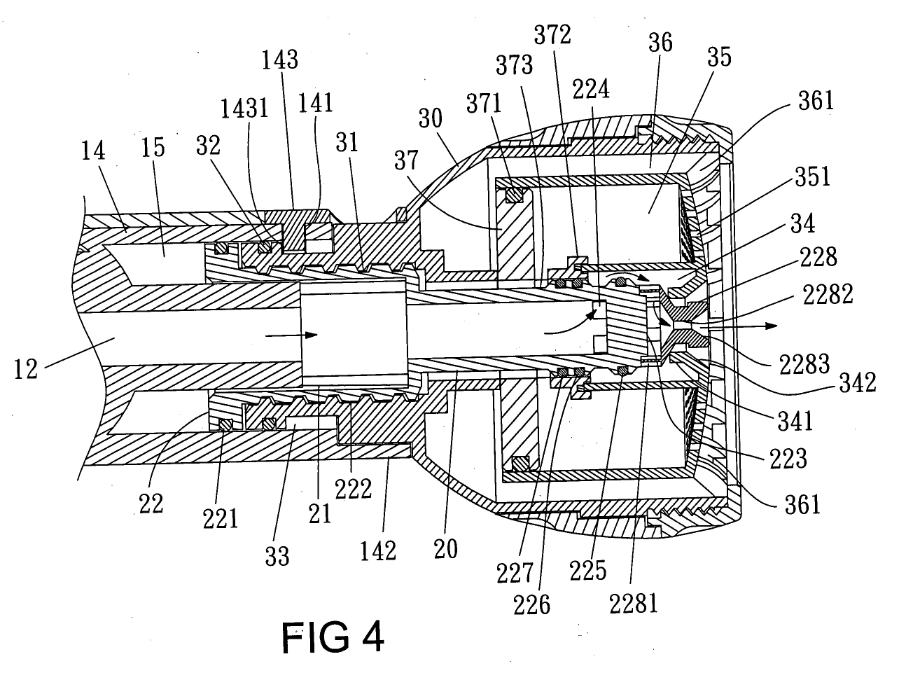

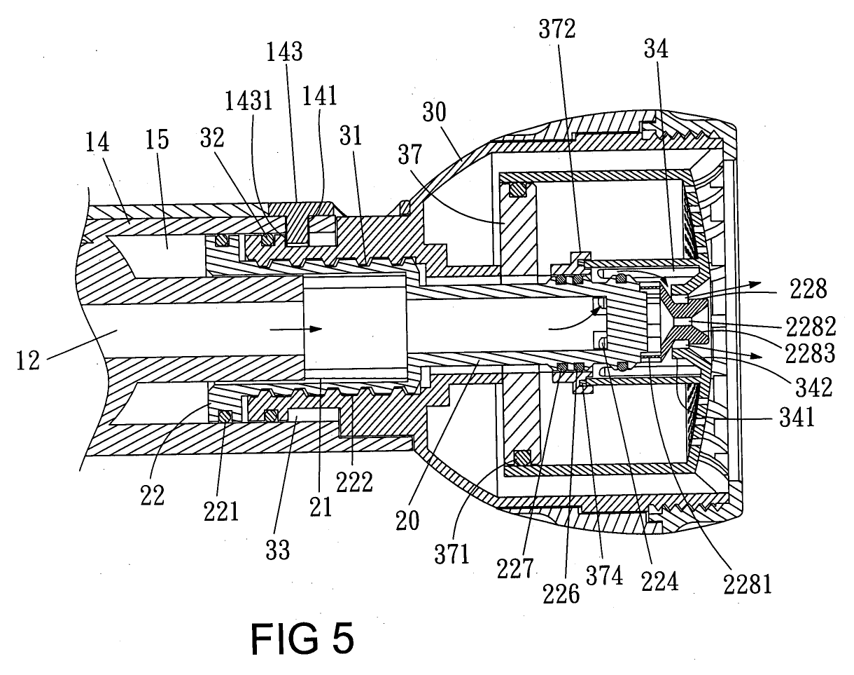

Referring to FIG. 4, when rotating the rotatable head 30 to let the nozzle member 228 in contact with the opening of the annular mouth of the first chamber 34, water enters into the first chamber 34 via the first outlets 224 of the adjusting member 20 and then goes out from the outward opening 2283 of the passage 2282 via the orifices 2281. In this status, the second and third seals 226, 227 are in contact with the neck 372 of the board 37.

As shown in FIG. 5, when rotating the rotatable head 30 to move the adjusting member 20 backward, a gap is defined between the nozzle member 228 and the inner periphery of the first chamber 34. The water enters into the first chamber 34 via the first outlets 224 of the adjusting member 20 and some water goes out from the outward opening 2283 of the passage 2282 via the orifices 2281, and then goes out from the passage 2282. Some water goes out from the gap between the nozzle member 228 and the inner periphery of the first chamber 34. The water hits the outward cone-shaped inner periphery 342 of the annular mouth 341 to form a specific watering pattern. In this status, the second and third seals 226, 227 are in contact with the neck 372 of the board 37 and the nozzle member 228 is located in the annular mouth 341.

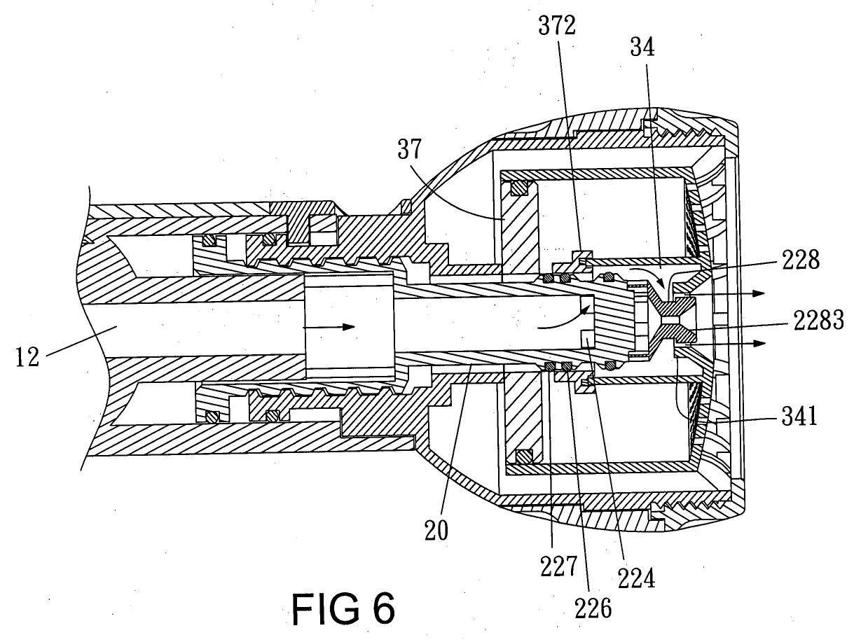

As shown in FIG. 6, when rotating the rotatable head 30 to move the adjusting member 20 backward to let the front end of the nozzle member 228 located in the annular mouth 341, the first outlets 224 of the adjusting member 20 are located in the neck 372 to form narrow passage therebetween. Besides, an annular passage is defined between the nozzle member 228 and the annular mouth 341. The water goes out from the narrow passage, the annular passage and the outward opening 2283 of the nozzle member 228. In this status, the second seal 226 and the third seal 227 are in contact with the neck 372 of the board 37.

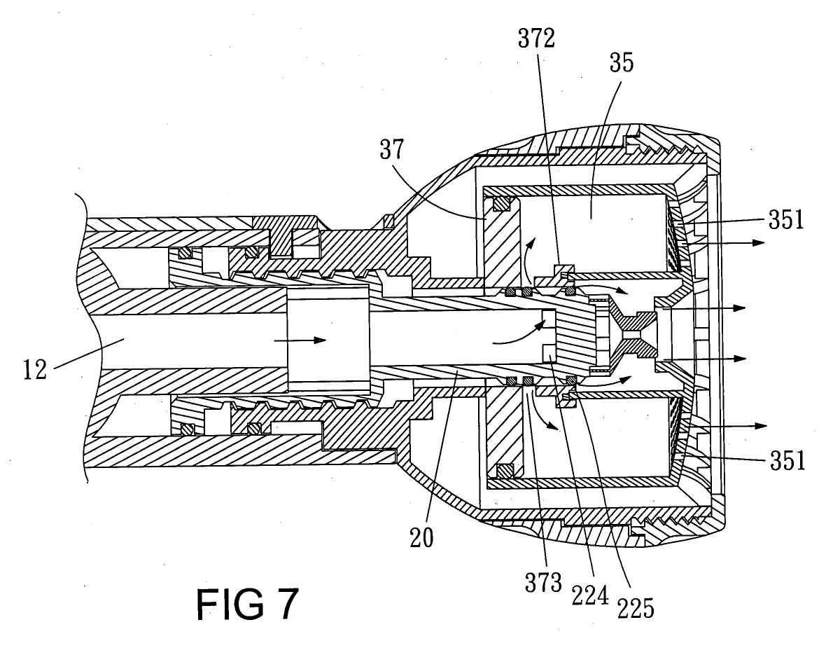

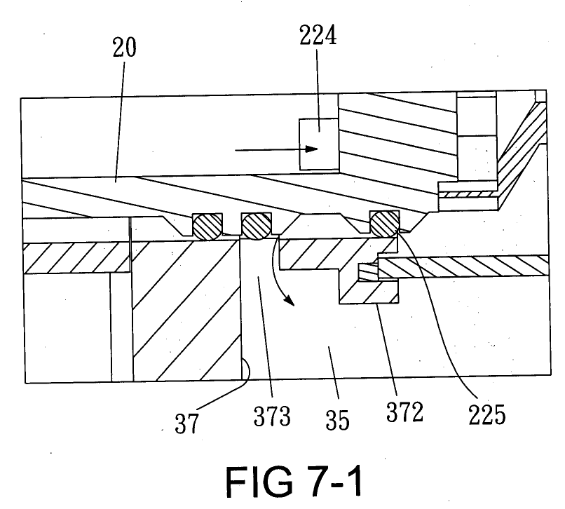

As shown in FIGS. 7 and 7-1, when moving the adjusting member 20 further from the position in FIG. 6, the first seal 225 is located to slightly block the opening of the neck 372, the water than is then introduced into the gap between the first outlets 224 and the apertures 373, and the gap between the first seal 225 and the neck 372, and then enters the first and second chambers 34, 35. The water goes out from the tiny holes 351 and the annular passage.

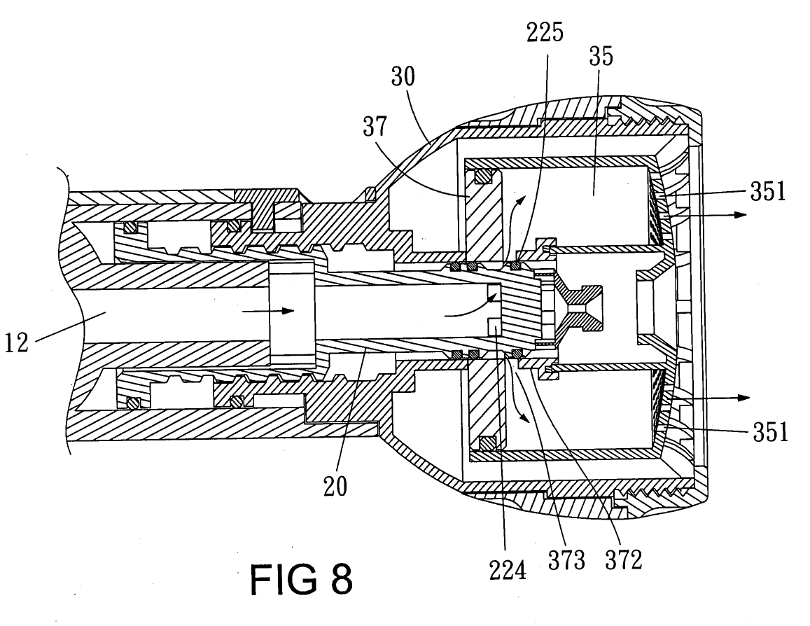

As shown in FIG. 8, when the adjusting member 20 is completely merged in the neck 372, and the first outlets 224 are located corresponding to the apertures of the neck 372. The first seal 225 is in contact with the inner periphery of the neck 372 and seals the neck 372. The water then enters the second chamber 35 via the first outlets 224 and the apertures 373, and goes out from the tiny holes 351.

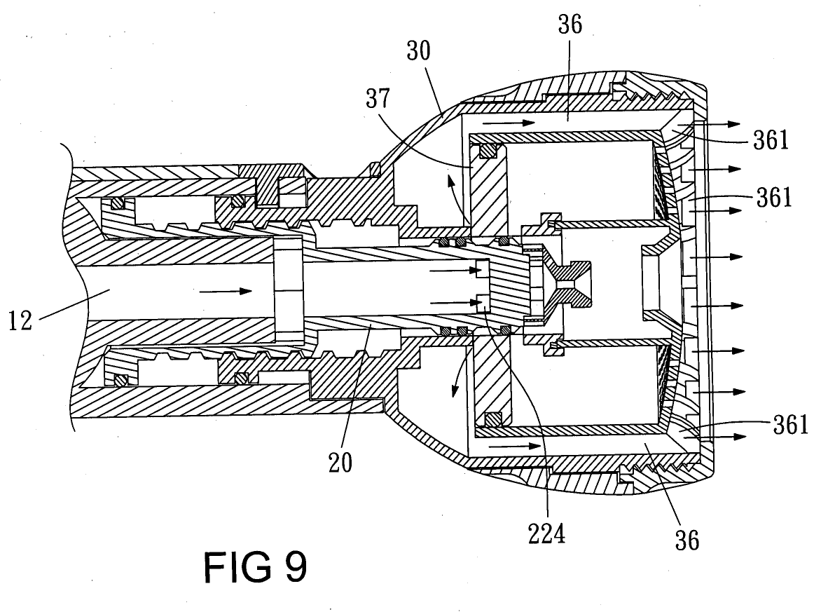

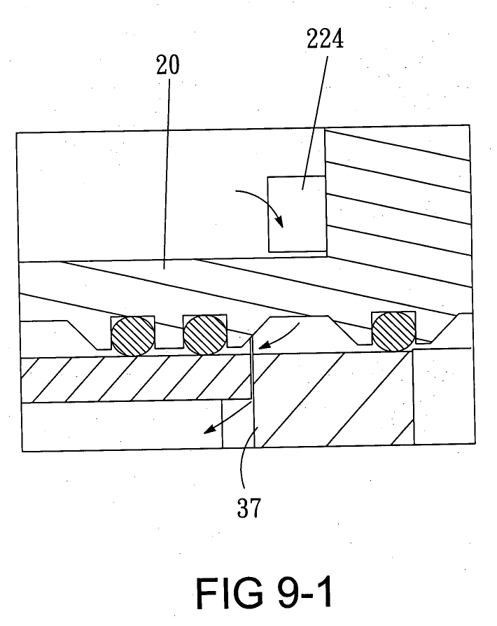

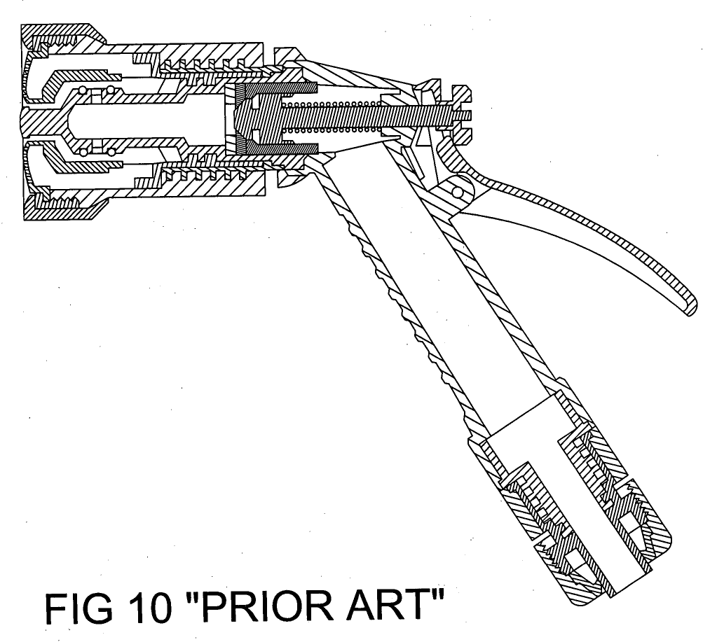

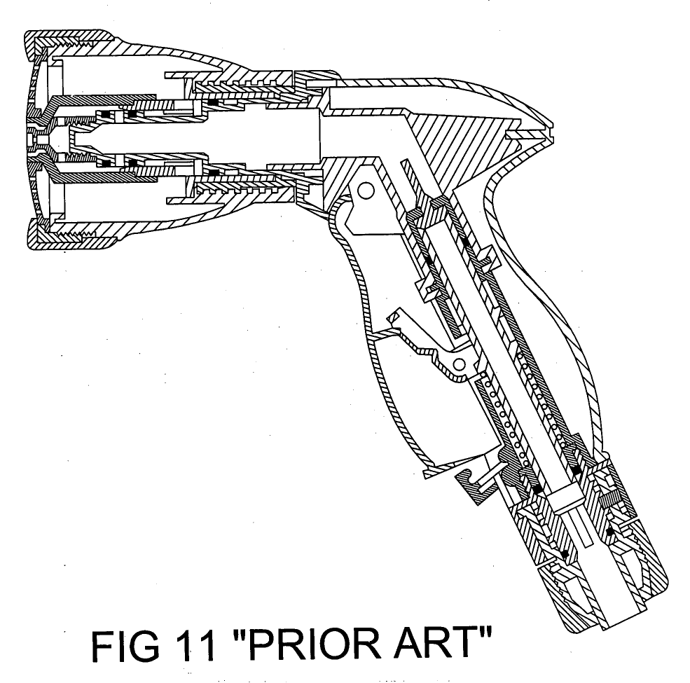

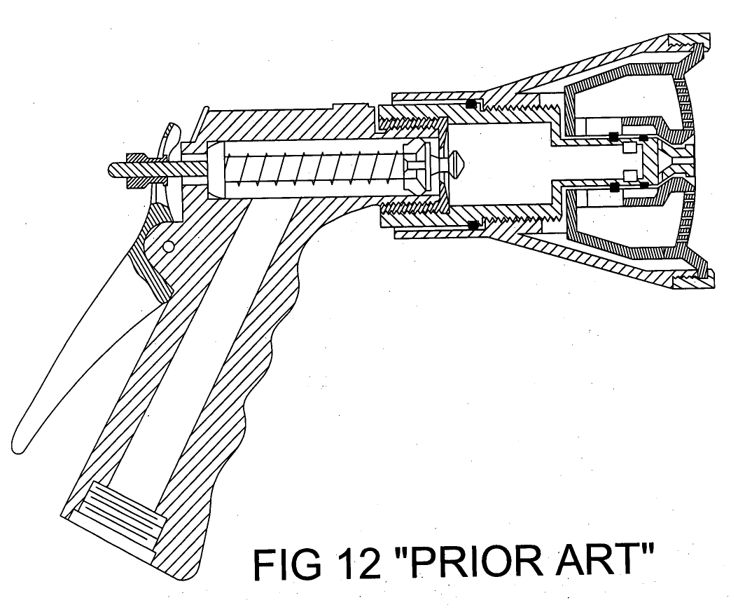

As shown in FIGS. 9 and 9-1, when rotating the rotatable head 30 to move the adjusting member 20 to a position beside the board 37 and in front of the first outlets 224, the water is guided into the third chamber 36 and goes out fro the elongate holes 361.

While we have shown and described the embodiment in accordance with the present invention, it should be clear to those skilled in the art that further embodiments may be made without departing from the scope of the present invention.

What is claimed is:

1. A watering nozzle comprising:
a handle having an inlet pipe received therein and a valve connected to the pipe, an outlet pipe connected to the first pipe and being communication with the inlet pipe, a trigger pivotably connected to the handle and a push rod cooperated with a spring connected between the trigger and the pipe;
an adjusting member having a rear end connected to the outlet pipe and a front end of the adjusting member being a closed end, a plurality of first outlets defined radially in the adjusting member and located close to the closed end, and
a rotatable head having a first chamber, a second chamber and a third chamber defined therein and a periphery of each of the three chambers having an outward cone-shaped inner periphery, a plurality of tiny holes and elongate holes, a board located in a rear end of the second chamber and a neck extending from the board, a plurality of apertures defined radially through the neck, a front end of the neck engaged with the first chamber, the adjusting member movable linearly when rotating the rotatable head to introduce water to enter into the first chamber, the second chamber or the third chamber via the first outlets.

2. The nozzle as claimed in claim 1, wherein the outlet pipe includes a pair of parallel rails and the rear end of the adjusting member includes grooves with which the rails are slidably engaged.

3. The nozzle as claimed in claim 1, wherein an outer tube is connected to the inlet pipe and the outlet pipe is received in the outer tube, a space is defined between the outlet pipe and the outer tube, the adjusting member and a rear end of the rotatable head are received in the space.

4. The nozzle as claimed in claim 3, wherein the outer tube includes a plurality of snap holes defined therethrough and the a retaining collar is mounted to the outer tube, a plurality of bosses extend from an inner periphery of the retaining collar and are engaged with the snap holes.

5. The nozzle as claimed in claim 1, wherein the rear end of the adjusting member has a flange and a seal is mounted to a periphery of the flange, the seal is in contact with an inner periphery of the outer tube.

6. The nozzle as claimed in claim 1, wherein the rear end of the adjusting member includes a threaded outer periphery and the rotatable head has a threaded inner periphery which is connected to the threaded outer periphery of the adjusting member.

7. The nozzle as claimed in claim 1, wherein a first seal, a second seal, and a third seal are mounted to the adjusting member and the first outlets are located between the first seal and the second seal.

8. The nozzle as claimed in claim 1, wherein a nozzle member is connected to a front end of the adjusting member and includes a plurality of orifices defined radially in a rear end thereof and a passage is defined longitudinally therein, a front end of the nozzle member includes an outward front end.

9. The nozzle as claimed in claim 4, wherein a seal is mounted to a rear end of the rotatable head and in contact with the inner periphery of the outer tube, the rotatable head includes an annular recess so that the bosses of the retaining collar are engaged.

10. The nozzle as claimed in claim 1, wherein an annular mouth extends inward from a front end of the rotatable head and located in the fist chamber.
